(19) United States
(12) Patent Application Publication
(10) Pub. No.: US 2004/0041423 A1
(43) Pub. Date: Mar. 4, 2004

(54) Clamp and method for handling objects

(76) Inventor: Steven Earl Cannon, Red Deer (CA)

Correspondence Address: One World Trade Center, Suite 1600, 121 S.W. Salmont Street, Portland, OR, 97204, US

(21) Appl. No.: 10/233,146

(22) Filed: Aug. 28, 2002

(51) Int. Cl. B25J 15/12; B25J 1/00

(52) U.S. Cl. 294/100; 294/19.1

(57) ABSTRACT

The invention relates to an apparatus for handling objects, especially objects located in a well. The apparatus comprises a clamp and a clamp actuator. The clamp has a plurality of gripping members each having at least one gripping surface for gripping an object there between; the gripping members are moveable between an unclamped position and a clamped position. The clamp actuator is moveable between an engaged and unengaged position, wherein in the engaged position the actuator applies a sufficient compressive force onto the gripping members to move the members to their clamped position, and wherein in the unengaged position the compressive force of the actuator is sufficiently reduced that the gripping members can return to the unclamped position.

### FIELD OF THE INVENTION

The present invention relates generally to tools for handling target objects at a distance and particularly to specialty clamps for installing and retrieving components from inside a well.

### BACKGROUND OF THE INVENTION

In the oil & gas industry “plungers” are pistons that are free to travel axially inside a well bore to evacuate production liquids (typically water or oil) that have accumulated during well operation. Various means are in use to “lift” a plunger causing it to movewithin the pipe string during normal operation as a result of which a slug of production liquid is elevated by the plunger to exit via an outflow line, however, anytime down-hole work is done for service or other reasons, the plunger must be removed temporarily. Further, plungers are necessarily removed periodically for their inspection, maintenance, and replacement.

A conventional plunger installation method is to simply drop the plunger down the upper extremity of the well bore on to the top of the master valve. Disadvantageously, this creates a risk of damage to the master valve and sparks resulting from the impact of the plunger. To remove the plunger from the well, some workers merely remove the top of the wellhead assembly and permit the plunger to shoot out of the well bore under pressure. Disadvantageously, this creates a risk of personal injury to the service technician as well as to people in proximity to the wellhead at the time of service. Most modern plunger lift systems do have a catcher assembly, but even with these in place the service technician may not be able to reach far enough down the tube string to grip the plunger to remove it from the catcher by hand. In other cases the catcher assembly has also failed to operate. More commonly, skilled Plunger Lift Technicians now use a tool of some kind to more carefully and safely install or extract plungers from pipe strings. The following four publicly available tool designs are known to the inventor.

The “noose” tool design is based on an elongate rod with a short loop of flexible cable or rope extending from its lower end. The operator positions the tool in the top of the wellhead, then pushes it down into the wellhead in a manner that allows the noose to surround the plunger top and thereafter (depending upon the particular embodiment) pulls on or twists the rod so as to close or wrap the noose around the top of the plunger sufficiently to hold its weight during transport. The reverse procedure is applied to install a plunger by unwrapping the noose to release the plunger after it is sitting on top of the master valve.

The “spring” tool design is an elongate rod having a helically coiled end segment forming a “spring” like portion that may be compressively forced over the neck of a plunger and then shakingly disengaged therefrom by gravitational and shearing forces to release the plunger into the pipe string.

The “4 slotted non-locking sleeve” tool design is a relatively crude friction or interference fit based tool with an elongate rod having a split, cylindrically shaped (i.e. a collet) component with 4 slots forming 4 resilient gripping members that may be compressively forced over the neck of a plunger and then shakingly disengaged therefrom by gravitational and shearing forces to release the plunger into the pipe string. Alternately, depending upon the embodiment and whether release is downhole or uphole, a screwdriver may be used to pry or otherwise release the plunger from the tool's grip.

The “2 slotted non-locking sleeve” tool design is a very crude friction or interference fit based tool with an elongate rod having a split cylindrically shaped component with 2 slots forming 2 resilient gripping members that may be compressively forced over the neck of a plunger and then shakingly disengaged therefrom by gravitational and shearing forces to release the plunger into the pipe string, very similar to the 4 slotted model.

In the course of handling (installing or extracting) a plunger, the tool by which it is carried must apply sufficient plunger holding force to at least overcome the weight of the plunger.For a given mass of plunger the tool needs to be designed to maintain sufficient gripping or holding force, such as to avoid accidental release which might otherwise occur due to increased momentary force of brief accelerations resulting from sudden changes in the movement of the gripping tool and plunger combination. Most of the conventional plunger handling tools have a frictional or interference fit (sometimes referred to as tolerance) that must be overcome by inward pressure at the time the plunger is inserted into the gripping head of the tool—then again by outward pulling at the time of release of the plunger from the gripping head of the tool. The problem with such conventional plunger handling tools is that the greater this frictional or interference fit is the more difficult it is to insert or release plungers from the gripping means (a clamp in some embodiments), even though it also means the plunger will be gripped more securely during transport. Further, in those conventional designs that rely on the resiliency of the gripping means (springs and slots) to maintain that tolerance of fit over time, the tool will become unreliable as a result of metal fatigue preventing a full recovery of the shape of the gripping means and a reduction in the tolerance of fit necessary to counteract the increased momentary force of brief accelerations during transport. In the absence of an independent means of maintaining the shape of the gripping means (i.e. which does not rely on the resiliency of the gripping head), the tool eventually will not even be able to overcome the weight of the plunger itself at which point the tool is no longer useful. Consequently, in summary, the tools that grip best are the most difficult to install and release, while the tools easiest to install and release tend to be the least reliable and have the shortest service life.

The prior art in the oil field service tool industry has concentrated on teaching variations on a frictional or interference fit means of engagement, which friction must be overcome (ahigh tolerance design problem) in order to release a plunger. Upon achieving a frictional threshold, whether intended or not, the non-locking gripping head of all of the conventional tools releases the plunger such that as the tool ages or is damaged, a condition arises as a result of which the tool will not engage the plunger effectively or will fail to maintain engagement until intentionally released. Even the very simple noose based tool design suffers degradation of operational control due to deformation of the noose element making the tool difficult to either engage or disengage, potentially resulting in an unintentional release of the plunger from the tool.

The only “non-frictional” design applicable to the oil and gas industry of which the applicant is aware is that of IPS (Integrated Production Services), who offer proprietary tools for custom plungers, including a “key and slot” combination that permits users to slideably engage the head of a plunger with a mating tool into which the head of the plunger may be inserted thereafter rotating the tool a partial turn for a (non-locking) engaging action that permits the plunger to be transported inside the wellhead. Disadvantageously, the IPS design permits relatively significant motion of the plunger while in the gripping head of the tool, thereby increasing the risk that the plunger will shake free and drop from the gripping head or otherwise make unintended contact with components inside the pipe string.

Disadvantageously, none of the above conventional designs permit the retrieval and installation of plungers reliably, safely, and easily. It is therefore desirable to provide a design that improves on conventional technologies and solves some of their problems.

### SUMMARY OF THE INVENTION

The present invention, in two of its aspects, is an apparatus for and a method of holding the gripping surfaces of a specialty clamp or gripping head in a clamped position for a simple, inexpensive to manufacture device that may be used reliably, safely, and easily to handle a target object in a well. Adding means for locking the gripping members and surfaces in such engaged position wherein they hold an object, further enhances the advantage of reliable engagement, permitting the safe handling of an object even in hazardous environments.

Advantageously, because the gripping surfaces are being held in position once they engage an object, the present invention does not rely on the inherent stiffness of the material from which the gripping members are fabricated, for maintaining a grip on the object. Radial compression of the gripping members by a clamp actuator adds additional gripping force on the object beyond the grip provided by the radial stiffness and coefficient of sliding friction applied by the gripping surfaces to the object as a result solely of the inherent stiffness of the material of the gripping members. As a direct result of the use of such independent means of holding the gripping members in position, it is possible to insert an object between the gripping members while applying little or no force, since the gripping members may be fully relaxed during either insertion or release. Advantageously, locking the “holding means”, or clamp actuator in one embodiment, adds further reliability to the present apparatus and method by reducing the risk of an accidental release of the target object.

The holding and locking functions are achieved by a structure that includes a plurality of gripping members and an annulus or cylinder (that together comprise a gripping head assembly), combined with an elongate handle and housing. A “gripping head assembly” is merely one embodiment of a “target engaging means” that uses a gripping form of engagement together with means for releasably closing (whether by compression or otherwise) the gripping members that comprise the gripping head element of the assembly.

To solve the high tolerance or friction design problem of the prior art requiring excess compressive force during insertion combined with excess tensile force during release, the present solution provides a clamp or gripping means the gripping members of which are relatively relaxed or substantially free moving during both insertion and release. To solve the reciprocal problem of unreliable gripping during work piece transport, the present solution is to provide a gripping means that may be locked during transport. A related, but peripheral advantage of using a simple, independent, mechanical means for maintaining the position of all elements of the gripping head is high reliability together with a long service life for the resulting device.

Advantageously, the present invention adds (to conventional slot head technology) simple means for holding and locking in position a plunger or other object when it is engaged by the gripping head of this novel device that securely holds and freely releases an object only in response to an operator's actions rather than upon achieving a frictional threshold. Using this device technicians are able to bypass a catcher assembly and place a plunger gently on top of the master valve ensuring that the plunger does not accidentally fall from the catcher assembly and hit the master valve thereby breaking the seal of or causing damage to the master valve. Non-frictional engagement improves both the attachment to and the release of an object, while the locking means maintains that engagement against accidental or unintentional release.

It is contemplated that the apparatus aspect of the present invention will provide additional versatility through the use of interchangeable gripping heads for different sizes of object including different designs of plunger.

According to one aspect of the invention, there is provided an apparatus for handling objects in a well. The apparatus comprises:

a clamp comprising a plurality of gripping members each having at least one gripping surface for gripping an object there between, the gripping members being moveable between an unclamped position and a clamped position; and

a clamp actuator moveable between an engaged and unengaged position, wherein in the engaged position the actuator applies a sufficient compressive force onto the gripping members to move the members to their clamped position, and wherein in the unengaged position the compressive force of the actuator is sufficiently reduced that the gripping members can return to the unclamped position.

The clamp may include a plurality of gripping members radially disposed about a gripping axis, and the clamp may apply a compressive force directed to the gripping axis. The actuator may comprise an annular collar moveable along the gripping axis, between an engaged position over and around the gripping members, and an unengaged position substantially off the gripping members. The gripping members may each have a distal and proximal end, and are fastened at their proximal ends to a clamp base. In particular, the gripping members each may be pivotally connected at their proximal ends to a clamp base.

The gripping members may be biased to an unclamped position. The apparatus may also be provided with locking means for maintaining the position of the clamp relative to the clamp actuator, e.g. a bolt and catch assembly.

The plurality of gripping members may be radially disposed about a common gripping axis, and the clamp actuator may comprise an annular collar slidable into an engaged position over the gripping members, and an actuator shaft with a distal end attached to the collar. The clamp may further comprise a clamp shaft having a distal end attached to the gripping members; the clamp shaft is axially slidable relative to the actuator shaft. The actuator shaft may include an axially extending slot and the clamp shaft may be axially slidable within the actuator shaft; the clamp may include a bolt protruding from the surface of the clamp shaft and slidable along the actuator shaft slot, such that an operator holding the apparatus at around the proximal end of the actuator shaft can move the clamp between its clamped and unclamped positions by moving the bolt along the slot.

According to another aspect of the invention, there is provided a use of an apparatus for handling objects in a well; the apparatus comprises a clamp comprising a plurality of gripping members each having at least one gripping surface and being moveable between an unclamped position and a clamped position; and a clamp actuator. The use is characterized by a moving of the actuator between an engaged and unengaged position, wherein in the engaged position the actuator applies a sufficient compressive force onto the gripping members to move the members to their clamped position and engage an object located therebetween, and wherein in the unengaged position the compressive force of the actuator is sufficiently reduced that the gripping members can return to the unclamped position and disengage the object.

The span of the gripping members in its unclamped position and the dimensions of the clamp actuator may be within the diameter of the well, such that the apparatus can engage or disengage the object when in the well.

The clamp and gripping members may be specially configured to grippingly engage a plunger. The clamp and gripping members may be configured to engage a downhole wireline component, and are adapted for use with means for positioning the apparatus deep in a well together with means for remotely operating the clamp actuator.

The apparatus may be used in other applications other than wells. For example, the object may be a golf ball and in which case the clamp is adapted to engage at least one golf ball. Or, the object may be a fruit, a nut, or a vegetable and the clamp is adapted to engage the fruit, nut or vegetable without damage thereto. Or, the object may be a hive and the clamp comprises a mesh basket, moveable between an open position and a closed position, for use with suitable means for closing the basket around the hive, and the actuator comprises an annular collar moveable along the gripping axis between an engaged position over and around the mesh basket for the purpose of stabilizing and holding the mesh basket in a closed position around the hive.

The accompanying drawings, which are incorporated in and constitute a part of this specification, illustrate preferred embodiments of the apparatus and method according to the invention and, together with the description, serve to explain the principles of the invention.

### BRIEF DESCRIPTION OF THE DRAWINGS

The present invention, in order to be easily understood and practised, is set out in the following non-limiting examples shown in the accompanying drawings, in which:

FIG. 1 is an exploded perspective view of a clamping apparatus for clamping plungers in oil and gas wells, according to one embodiment of the invention;

FIG. 2 is a perspective view the clamping apparatus shown in FIG. 1 showing the gripping head assembly in an open position;

FIG. 3 is a perspective view of the clamping apparatus shown in FIG. 1, showing the gripping head assembly in a closed position; and

FIG. 4 is a schematic side view of the clamping apparatus installed in the tube string of a wellhead (partially cut away for clearer viewing).

### DETAILED DESCRIPTION OF THE PREFERRED EMBODIMENT

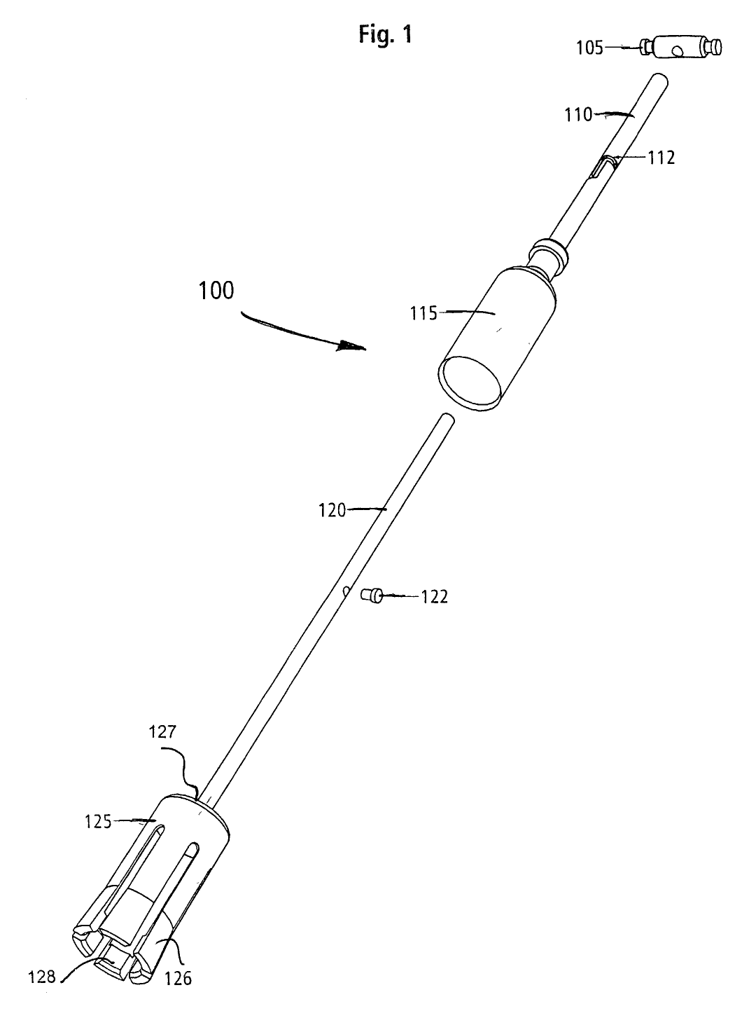

According to one embodiment of the invention and referring In FIG. 1, a device for handling plungers in oil and gas well operations, denoted generally as 100 is shown having six main components, namely: handle 105, outer sleeve 110, clamp actuator 115, inner rod 120, actuator locking handle member 122, and clamp 125. Outer sleeve 110 may optionally have a suitably shaped and positioned opening 112 formed into its sidewall permitting access to inner rod 120 for the installation and operation of locking handle member 122. As shown, clamp 125 is a one-piece machined component having target engaging means in which the gripping head element, clamp 125, is comprised of a plurality of resilient gripping members 126, each gripping member 126 having at least one gripping surface 128 and being any suitably shaped and positioned resilient member fabricated into the sidewalls of an annulus or cylinder made from a material suited to engage the targets for which the particular embodiment of the apparatus aspect of the present invention has been fabricated. An embodiment based on a one-piece clamp 125 is hereafter used to describe the operation of and some manufacturing considerations relating to the implementation of various aspects of the present invention.

According to a preferred embodiment of the apparatus aspect of the present invention clamp 125 comprises a plurality of resilient gripping members 126 (each having a gripping surface 128) together with fastening means 127 for connecting (by spring biased hinges in one embodiment) said plurality of gripping members 126 together and also to inner rod 120. Fastening means 127 is situated at one (proximal) end of an annulus or cylinder into which resilient gripping members 126 have been machined, the opening for insertion of an object situated at an opposing (distal) end thereof. Said annulus will have a threaded or other suitable form of entry point machined or otherwise fabricated into said distal end permitting the permanent or releasable connection of inner rod 120 thereto by welded, threaded or other suitable means based on the application of the particular embodiment of the present invention.

To assemble device 100, various sub-assemblies are conveniently first created. Inner rod 120 is attached to clamp 125. And clamp actuator 115 is attached to outer sleeve 110. Thereafter the sub-assembly comprised of inner rod 120 and clamp 125 is inserted inside the sub-assembly comprised of outer sleeve 110 and clamp actuator 115, after which optional handle 105 may be attached to the end of inner rod 120 that extends through outer sleeve 110. And, the optional locking handle member 122, if being used, may be inserted through a suitably shaped and positioned opening 112 in outer sleeve 110 for the purpose of fastening handle member 122 to inner rod 120.

In fabricating the foregoing machined embodiment of clamp 125 it is desirable to avoid using any material that will fracture at stress points. Further, fabrication of both inner rod 120 and clamp 125 using brass or other suitable alloy to reduce the risk of sparks when operating the device near flammable vapors is highly desirable. The appropriate tolerances between outer sleeve 110 and inner rod 120 as well as between clamp 125 and clamp actuator 115 will be affected by the particular materials selected. In the fabrication of outer sleeve 110 and clamp actuator 115, 316 stainless steel has been found to be suitable for use in devices manufactured for oil and gas well applications. If optional handle member 122 is to be installed by threaded means, it is desirable to use a thread locking compound to ensure that handle member 122 stays securely threaded to inner rod 120. Handle member 122 may also be fabricated using brass to reduce the risk of sparks while operating the device inside a well head.As a result of the method aspect of the present invention the radial stiffness of the gripping members can, by material selection, be reduced because the required radial force directed normal to the axis of the gripped object is provided not by the stiffness of clamp 125, but by the radial compression of clamp actuator 115. This is useful since it permits manufacturing clamp 125 with less radial stiffness (less expensive material and machining), thereby making engagement and removal of the object easier, especially if the coefficient of sliding friction between the outer surface of clamp 125 and the inside surface of clamp actuator 115 is selected to be relatively low.

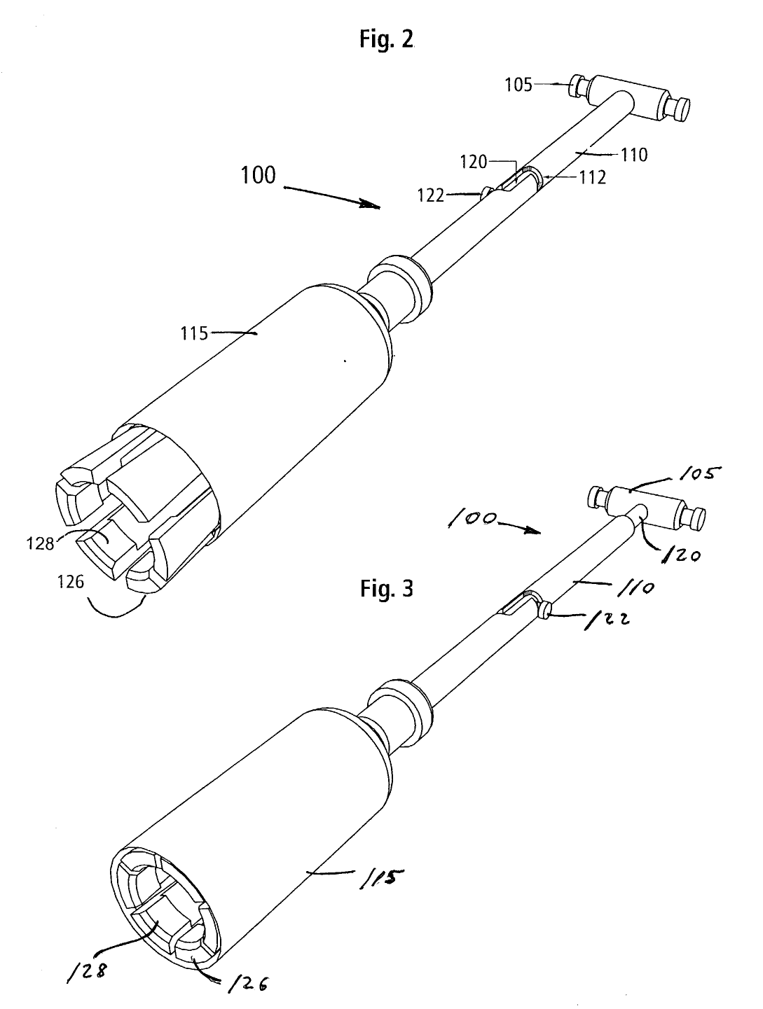

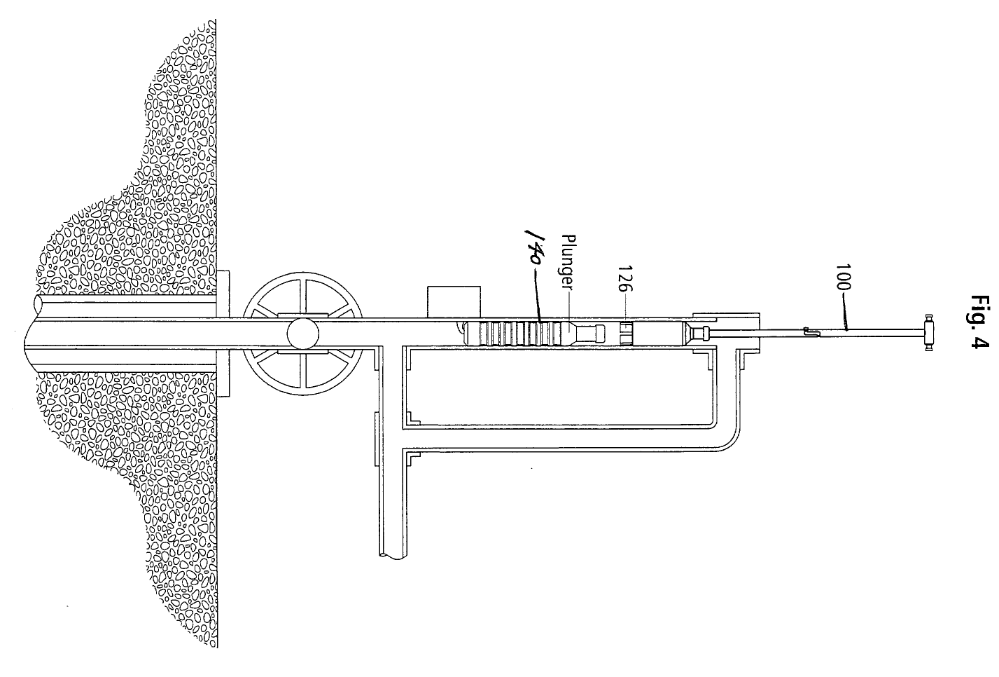

To operate device 100 from an open position as shown in FIG. 2, push outer sleeve 110 away from handle 105 causing clamp actuator 115 to slide over the top of the exposed portion of clamp 125 thereby compressing gripping members 126 into a closed position as shown in FIG. 3. When a plunger 140, shown only in FIG. 4, is inserted between gripping members 126 and device 100 is operated to said closed position, clamp 125 is said to “engage” the target plunger. Where device 100 includes optional handle member 122, enabling “dual action locking”, the act of so engaging a plunger (with clamp actuator 115 holding gripping members 126 in a closed position) is the “first locking action” as a result of which gripping members 126 remain “locked” in a compressed condition until clamp actuator 115 is slideably disengaged from the gripping members 126 of clamp 125. The “second locking action”, locking clamp actuator 115 in place, occurs when the device operator suitably rotates handle member 122 in opening 112 until movement stops, such that device 100 is locked in a closed position ready to transport a plunger engaged in clamp 125. To release the plunger when at its desired location, rotate handle member 122 in an opposite direction and pull outer sleeve 110 towards handle 105 causing clamp actuator 115 to slide away from clamp 125 thereby partially exposing and decompressing gripping members 126, putting device 100 in an open position.

With a suitably shaped and positioned opening 112, device 100 may also be locked in an open position, with gripping members 126 uncompressed, using handle member 122. It is desirable to lock device 100 in an open position while, as shown in FIG. 4, device 100 is being lowered into a well head for the purpose of engaging a plunger. With gripping members 126 in an exposed and decompressed condition the insertion force required to place device 100 over the neck of a plunger is nearly zero, making installation very easy compared to traditional friction fit designs. Similarly, when releasing a plunger from device 100 locking in an open position ensures a clean disengagement simplifying removal of device 100 from the well head.

In device 100's open condition, an outer end portion of clamp 125 extends outside clamp actuator 115 permitting the plurality of resilient gripping members 126 to expand outwardly to a diameter sufficient to permit a portion of a plunger (or other object for which the particular embodiment has been designed) to be inserted between said plurality of gripping members 126. In device 100's closed and locked condition, clamp 125 is firmly and securely engaged with a portion of the plunger preventing clamp 125 from disengaging in response to shaking or impact during the extraction process of withdrawing device 100 together with the plunger from the wellhead.

In a preferred embodiment of device 100, the releaseable compression of gripping members 126 is achieved via a mechanical interaction between concentric cylinders. The gripping members 126 of clamp 125 form an inner cylinder retractable inside clamp actuator 115 (an outer cylinder) to cause gripping members 126 to be substantially uniformly radially compressed whenever the inner cylinder slides inside the outer cylinder. A person of skill in the art of mechanical components would understand that the cause of the sliding interaction makes little difference to the nature of the interaction or to its effect. Similarly the use of concentric cylinders to achieve substantially uniform radial compression of gripping members 126 is not essential, but is simply one means of causing gripping members 126 to engage a portion of a plunger in order to grip it in a manner that will tend not to be disengaged by a non-destructive force resulting from the inertial and gravitational forces of shaking.

Advantageously, a preferred embodiment of device 100 has locking means, such that the object engaged cannot slip or be accidentally pulled from the device during object installation or retrieval, with no risk of accidental unwrapping (as in a noose design) or release (as in spring design). In a preferred embodiment, device 100 may be operated from at least two different positions to permit easy operation with objects at different distances.

Advantageously, since device 100 does not require downward pressure on a plunger when engaging, the risk that a plunger will accidentally fall onto a master valve is reduced. Similarly, a plunger may be safely and gently released by unlocking and slidingly disengaging clamp 125, requiring negligible force to withdraw device 100. Further, device 100 is a strong and durable design according to which gripping members 126 are protected from accidental crushing or other deformation by remaining retracted inside clamp actuator 115 while not in use. Device 100 may be manufactured or setup for use with any size of “fish neck” plunger (for example, but not in limitation, both 1.375″ and 1.75″ neck dia.) by changing the gripping head assembly or selecting a device with a different size of gripping head assembly pre-installed.

When using non-resilient materials for hinged gripping members a spring bias will be appropriate for clamp 125 to work properly (i.e. spring biasing means to maintain the target engagement means in an open condition when not engaged). An automatically engaging model of device 100 with a spring loaded button inside and on the axis of clamp 125 is contemplated according to which when said button is pushed against a target object spring tension is released causing clamp 125 to be retracted inside clamp actuator 115 simultaneously engaging an object. The means for locking clamp actuator 115 may also be varied to include a strike pin to suddenly engage a gripping member 126, which could be disengaged by various means. In yet a further embodiment, cable means could be used to cause the target engagement means to operate to a closed condition. Alternate gripping head closing means contemplated include both cable and lever actuated embodiments as well as a worm gear driven version of such lever actuated means of closing gripping members 126 of the gripping head assembly. An electrically controlled, solenoid operated version of the gripping head assembly is contemplated for longer distance (e.g. deep well) embodiments of device 100 adapted for remote operation while suspended by chain or cable to reach deeper targets.

According to an alternate embodiment of the apparatus aspect of the present invention, clamp 125 may comprise an assembly of distinct components (e.g. a plurality of gripping surfaces on hinged, spring-biased, gripping members that together form clamp 125) suitably positioned and connected to engage the target objects for which the particular embodiment has been fabricated. It is contemplated that with either the resilient or hinged gripping member embodiment of clamp 125 the closing means may be implemented using concentric cylinders. Similarly, for either embodiment of gripping members, the closing means may be solenoid driven. However, only for the hinged, spring-biased gripping members would a manual cable loop closing means appear to be practical. As there are a number of standard sizes of plunger, device 100 will necessarily be fabricated with an appropriate number of increments in the size of clamp 125.

In a further alternate embodiment gripping surfaces 128 may be coated with foam rubber or otherwise adapted for soft contact with fragile targets, rather than machined into gripping members 126 as is suitable for use with metal plungers in an oil and gas well application.

Depending on whether a particular embodiment is to be used in an industrial, agricultural, or domestic application—the strength requirements and device weight limits will vary, requiring or permitting that device 100 be fabricated from steel, brass, graphite, plastic or other suitable material. Specifically, device 100, suitable components being fabricated from a light weight yet strong material (such as carbon fibre) and having appropriate modification to the size of clamp 125 including to the length of gripping member 126 and to the shape of gripping surface 128 may be applied to handle golf balls in a variety of common situations. It is contemplated that a golfing application would be further enhanced by the inclusion of telescoping means added to and adapted for use with outer sleeve 110 and inner rod 120.

In a further alternate embodiment, the target engaging means may, rather than a pure gripping means, comprise other releasable means suited to the subject target object and application. For example, but not in limitation, device 100 applied as a bee or wasp hive removal and disposal device is contemplated to be based on complementary screen or mesh baskets in place of clamp 125 and clamp actuator 115, said baskets operable to a closed position by a cable or rope closing means and restored to an open position by spring metal bands.

It is contemplated that the target engaging means of the apparatus aspect of the present invention may comprise any of a: gripping head assembly (all gripping head assemblies comprising a gripping means and a closing means), vacuum head assembly, electro-magnetic head assembly, hooking or piercing head assembly, or an adhesive head assembly.

Although other applications will now be apparent to persons skilled in the art of device design, alternate uses contemplated for the present invention include: downhole wireline component retrieval or installation tool; and a nut, fruit or vegetable picker suitably adapted in relation to the size and type of the target engaging means, as well as in accordance with the variations taught above respecting each of the elements that together comprise device 100.

Although the disclosure describes and illustrates various embodiments of the invention, it is to be understood that the invention is not limited to these particular embodiments. Many variations and modifications will now occur to those skilled in the art of resource allocation. For full definition of the scope of the invention, reference is to be made to the appended claims.

What is claimed is:

1. An apparatus for handling objects in a well, comprising:
a clamp comprising a plurality of gripping members each having at least one gripping surface for gripping an object there between, the gripping members being moveable between an unclamped position and a clamped position; and
a clamp actuator moveable between an engaged and unengaged position, wherein in the engaged position the actuator applies a sufficient compressive force onto the gripping members to move the members to their clamped position, and wherein in the unengaged position the compressive force of the actuator is sufficiently reduced that the gripping members can return to the unclamped position.

2. The apparatus as claimed in claim 1 wherein the clamp includes a plurality of gripping members radially disposed about a gripping axis, and the clamp applies compressive force directed to the gripping axis.

3. The apparatus as claimed in claim 2 wherein the actuator comprises an annular collar moveable along the gripping axis, between an engaged position over and around the gripping members, and an unengaged position substantially off the gripping members.

4. The apparatus as claimed in claim 2 wherein the gripping members each have a distal and proximal end, and are fastened at their proximal ends to a clamp base.

5. The apparatus as claimed in claim 2 wherein the gripping members each have a distal and proximal end, and are pivotally connected at their proximal ends to a clamp base.

6. The apparatus as claimed in claim 2 wherein the gripping members are biased to an unclamped position.

7. The apparatus as claimed in claim 1 further wherein there are provided locking means for maintaining the position of the clamp relative to the clamp actuator.

8. The apparatus as claimed in claim 7 further wherein the locking means comprises a bolt and catch assembly.

9. The apparatus as claimed in claim 1 wherein the plurality of gripping members are radially disposed about a common gripping axis, and the clamp actuator comprises an annular collar slidable into an engaged position over the gripping members, and an actuator shaft with a distal end attached to the collar.

10. The apparatus as claimed in claim 9 wherein the clamp further comprises a clamp shaft having a distal end attached to the gripping members, the clamp shaft being axially slidable relative to the actuator shaft.

11. The apparatus as claimed in claim 10 wherein the actuator shaft includes an axially extending slot and the clamp shaft is axially slidable within the actuator shaft, the clamp including a bolt protruding from the surface of the clamp shaft and slidable along the actuator shaft slot, such that an operator holding the apparatus at around the proximal end of the actuator shaft can move the clamp between its clamped and unclamped positions by moving the bolt along the slot.

12. Use of an apparatus for handling objects in a well, the apparatus comprising a clamp comprising a plurality of gripping members each having at least one gripping surface and being moveable between an unclamped position and a clamped position; and a clamp actuator, the use being characterized by moving the actuator between an engaged and unengaged position, wherein in the engaged position the actuator applies a sufficient compressive force onto the gripping members to move the members to their clamped position and engage an object located therebetween, and wherein in the unengaged position the compressive force of the actuator is sufficiently reduced that the gripping members can return to the unclamped position and disengage the object.

13. The use as claimed in claim 12 wherein the span of the gripping members in its unclamped position and the dimensions of the clamp actuator are within the diameter of the well, such that the apparatus can engage or disengage the object when in the well.

14. The apparatus as claimed in claim 3 wherein the clamp and gripping members are configured to grippingly engage a plunger.

15. The apparatus as claimed in claim 3 further wherein the clamp and gripping members are configured to engage a downhole wireline component, and are adapted for use with means for positioning the apparatus deep in a well together with means for remotely operating the clamp actuator.

16. An apparatus for handling objects, comprising:
a clamp comprising
a plurality of gripping members each having at least one gripping surface for gripping an object there between, the gripping members being moveable between an unclamped position and a clamped position; and
a clamp shaft having a distal end attached to the gripping members; and
a clamp actuator comprising
a cylindrical collar slidable between an unengaged position and an engaged position over the gripping members, wherein in the engaged position the collar applies a sufficient compressive force onto the gripping members to move the members to their clamped position, and wherein in the unengaged position the compressive force of the collar is sufficiently reduced that the gripping members can return to their unclamped position; and
an actuator shaft having a distal end attached to the collar;
wherein the clamp shaft is axially slidable relative to the actuator shaft, such that an operator holding the apparatus adjacent its proximal end can move the clamp between its engaged and unengaged positions by moving the actuator and clamp shafts relative to each other.

17. The apparatus as claimed in claim 16 wherein the object is a golf ball and the clamp is adapted to engage at least one golf ball.

18. The apparatus as claimed in claim 16 wherein the object is a fruit, a nut, or a vegetable and the clamp is adapted to engage the fruit, nut or vegetable without damage thereto.

19. The apparatus as claimed in claim 16 wherein the object is a hive and the clamp comprises a mesh basket, moveable between an open position and a closed position, for use with suitable means for closing the basket around the hive, and the actuator comprises an annular collar moveable along the gripping axis between an engaged position over and around the mesh basket for the purpose of stabilizing and holding the mesh basket in a closed position around the hive.
